(19) United States
(12) Patent Application Publication
(10) Pub. No.: US 2025/0019988 A1
(43) Pub. Date: Jan. 16, 2025

(54) CLEANING ROBOT AND STEERING DEVICE THEREFOR AND CLEANING METHOD THEREOF

(71) Applicant: Cixi Handsome Pool Appliance Co., Ltd., Cixi City (CN)

(72) Inventor: Hangrui Lin, Cixi City (CN)

(21) Appl. No.: 18/901,109

(22) Filed: Sep. 30, 2024

(51) Int. Cl. E04H 4/16; C02F 1/00; F04D 1/00; F04D 29/22

(52) U.S. Cl. CPC E04H 4/1654; C02F 1/001; F04D 1/00; F04D 29/22

(57) ABSTRACT

The present invention discloses a cleaning robot and a steering device therefor and a cleaning method thereof. The cleaning robot does not rely on a circuit or sensor for path planning to perform cleaning operations, and has an automatic direction adjustment function by means of a physical structure design, which can improve working efficiency and reduce production costs.

### TECHNICAL FIELD

The present invention relates to the technical field of swimming pool cleaning equipment, and particularly relates to a cleaning robot and a steering device therefor and a cleaning method thereof.

### BACKGROUND

Pool cleaning robots are capable of automatically completing cleaning of one or more of bottom surface, sidewalls and water surface of pools, provide convenience for users to clean the pools, and are widely favored by the users. For example, Chinese patent No. CN101695832B discloses an underwater cleaning robot that travels smoothly, adjusts direction easily, and provides a basis for efficient cleaning of sidewalls.

However, existing underwater cleaning robots on the market have the following disadvantages: 1, before operation, it is necessary to plan and design paths according to shapes and structures of different swimming pools, and it is necessary to input corresponding procedures separately if other different swimming pools need to be cleaned later, resulting in complicated operation; 2, the cleaning robots using path planning have many control units on their internal structures and often rely on circuit operation, resulting in increased equipment cost and decreased underwater reliability, which is not conducive to promotion and use; 3, in some special scenarios, the planned path may differ from the actual swimming pool, which may cause actual working effect of the cleaning robot to fall short of expectations or lead to equipment damage. For example, when a large external object falls into the swimming pool and blocks a path of the cleaning robot or causes the cleaning robot to hit an obstacle, the cleaning robot cannot turn autonomously and requires human intervention, resulting in low working efficiency.

The present invention aims to solve at least one of the above problems, and provides a cleaning robot.

### SUMMARY

It is an object of the present invention to provide a cleaning robot for swimming pool cleaning without relying on a circuit or sensor for path planning and having an automatic steering function by means of a physical structure design, and a steering device and a cleaning method for achieving the function.

As a first embodiment, there is provided a cleaning robot for performing a cleaning operation in a swimming pool, including:
a cleaning body provided with a flow channel inlet, a flow channel and a flow channel outlet therein;
an upper cover mounted on the cleaning body, where an accommodating cavity is formed between the upper cover and the cleaning body, the upper cover is provided with two water spraying ports in communication with the accommodating cavity, and the two water spraying ports are arranged at an angle of about 180° therebetween;
a volute movably provided in the accommodating cavity and having a volute cavity and a volute outlet and a volute inlet in communication with the volute cavity;
a spiral guide mechanism acting between the volute and the cleaning body to guide the volute to rise and fall along a spiral track when the volute rotates;
a rotation locking mechanism acting between the volute and the upper cover to lock rotation of the volute when the volute outlet is in communication with one of the two water spraying ports; and
a volute resetting mechanism for driving the volute to displace vertically in a direction opposite to the spiral track to unlock the rotation locking mechanism; and
where the volute inlet is communicated with the flow channel outlet, and a centrifugal impeller is provided in the volute cavity to drive water to flow.

Preferably, the volute outlet is aligned with one of the water spraying ports to form a first operating state, the centrifugal impeller rotates to drive water to flow in the cleaning robot, and the volute rises and falls along the spiral track under the guidance of the spiral guide mechanism to cause the rotation locking mechanism to lock the volute in the first operating state.

Preferably, when the cleaning robot stops traveling, the centrifugal impeller stops rotating, the volute resetting mechanism drives the volute to rise and fall vertically to release locking of the rotation locking mechanism, then the centrifugal impeller rotates to drive water to flow, and under the guidance of the spiral guide mechanism, the volute outlet is aligned with the other water spraying port to form a second operating state, and the volute is locked by the rotation locking mechanism.

When the cleaning robot using the technical solution hits a wall of a swimming pool or an obstacle, a driving motor for driving the centrifugal impeller to rotate stops working so that the centrifugal impeller stops pumping water correspondingly, the volute is vertically displaced downward under the action of the volute resetting mechanism to unlock rotation lock of the volute, and then after the driving motor is started, the volute can be driven to continue rotating in an original spiral manner to re-establish a state in which the volute outlet and the water spraying port are aligned and locked. Similarly, when the cleaning robot travels to hit a wall or encounters an obstacle in the second operating state, the cleaning robot can switch back to and maintained in the first operating state by steering by the volute. That is, the robot can cyclically switch between the first operating state and the second operating state. This process does not require the user to plan a path in advance, but is achieved by aligning the volute outlet with one of the water spraying ports on the upper cover. That is, the robot changes direction by a pure mechanical structure. Here, the rotation locking mechanism and the volute resetting mechanism act in opposite directions of the volute. That is, one acts on the volute from top to bottom, and the other acts on the volute from bottom to top.

Preferably, the volute resetting mechanism is implemented by gravity of the volute, and the volute is movably arranged between the upper cover and the cleaning body in an up-and-down lifting manner, and can move between a high position and a low position of an up-and-down lifting stroke. Since the volute is reset by gravity, the volute outlet is aligned with the water spraying port when the volute is in the high position to discharge water.

As a second embodiment of the present invention, there is provided a steering device for a cleaning robot capable of performing a cleaning operation in a swimming pool, and the steering device includes:
a centrifugal impeller for driving water to flow inside and outside the cleaning robot;
an upper cover mounted to a cleaning body of the cleaning robot and forming an accommodating cavity therebetween, where the upper cover is further provided with two water spraying ports in communication with the accommodating cavity, and the two water spraying ports are arranged at an angle of about 180° therebetween;
a volute movably mounted in the accommodating cavity and having a volute cavity and a volute outlet and a volute inlet in communication with the volute cavity, where water driven by the centrifugal impeller is capable of applying a rotational moment to the volute to drive the volute to rotate when the water is discharged at the volute outlet;
a spiral guide mechanism acting between the volute and the cleaning body of the cleaning robot to guide the volute to rise and fall along a spiral track when the volute rotates;
a rotation locking mechanism acting between the volute and the upper cover to lock rotation of the volute when the volute outlet is in communication with one of the two water spraying ports; and
a volute resetting mechanism for driving the volute to displace vertically in a direction opposite to the spiral track to release rotation locking.

For the steering device using the technical solution, when the centrifugal impeller rotates, there is an included angle between the volute outlet and a radial direction due to a force applied by the centrifugal impeller or the volute to the water flow, so that the volute can have a tendency to rotate or rotates under the action of the rotational moment while driving the water flow; and when the robot stops traveling and displacing, the centrifugal impeller stops rotating to eliminate the rotational moment, the volute resetting mechanism drives the volute to displace vertically to release the rotation locking of the rotation locking mechanism, and then after the centrifugal impeller is restarted to rotate, the robot may switch to the second operating state. In this way, the robot continuously switches between the first operating state and the second operating state cyclically, thereby realizing automatic direction adjustment of the robot for cleaning. Here, the rotation locking mechanism and the volute resetting mechanism also act in opposite directions of the volute. That is, one acts on the volute from top to bottom, and the other acts on the volute from bottom to top.

As a third embodiment of the present invention, there is also provided a cleaning method of a cleaning robot as follows.

The cleaning robot is placed in a place to be cleaned, a volute outlet of the cleaning robot is aligned with one of two water spraying ports to form a first operating state, the cleaning robot travels in a first direction and sucks and filters water and then sprays out the water from the volute outlet, and garbage is collected in a garbage bin; when the cleaning robot stops traveling due to an external factor, the centrifugal impeller stops rotating to remove a rotational moment originally applied to a volute by the centrifugal impeller, and the volute vertically lifts and displaces by gravity to release rotation locking of the volute; then the centrifugal impeller is started again to guide water flow and apply a rotational moment to the volute, the volute outlet continues rotating to align with the other water spraying port to form a second operating state, and a rotation locking mechanism locks the volute in the second operating state; when the cleaning robot stops traveling again due to an external factor, the previous step is repeated to switch to the first operating state; and the robot cyclically switches between the first operating state and the second operating state until all cleaning operations are completed.

Preferably, the volute resetting mechanism is implemented by gravity of the volute.

Beneficial effects of the present invention include: compared with existing cleaning robots, the robot of the present invention cleans the swimming pool without relying on path planning. More specifically, the automatic steering function based on a mechanical steering structure enables the robot to change direction by itself when hitting a wall or encountering an obstacle and repeat the process until completing the cleaning, without requiring the user to plan the path in advance and monitor the operating state of the robot in the process, which has the advantages of high working efficiency and low production costs.

### BRIEF DESCRIPTION OF THE DRAWINGS

FIG. 1 is a schematic diagram of a structure and a traveling direction of a cleaning robot according to Embodiment I of the present invention;

FIG. 2 is a first exploded schematic diagram of a structure of the embodiment of FIG. 1;

FIG. 3 is a second exploded schematic diagram of the structure of the embodiment of FIG. 1;

FIG. 4 is a cross-sectional view of the structure of the embodiment of FIG. 1 with an upper cover removed;

FIG. 5 is an enlarged schematic diagram of a structure at C in FIG. 4;

FIG. 6 is a structural schematic diagram of the upper cover in the embodiment of FIG. 1;

FIG. 7 is a first structural schematic diagram of a volute in the embodiment of FIG. 1;

FIG. 8 is a second structural schematic diagram of the volute in the embodiment of FIG. 1;

FIG. 9 is a structural schematic diagram of a rotation stopper in the embodiment of FIG. 1;

FIG. 10 is a structural schematic diagram of a cleaning robot according to Embodiment II of the present invention;

FIG. 11 is a first exploded schematic diagram of a structure of the embodiment of FIG. 10; and

FIG. 12 is a second exploded schematic diagram of the structure of the embodiment of FIG. 10.

### REFERENCE NUMERALS IN THE DRAWINGS

cleaning robot 1, volute 2, upper cover 11, cleaning body 12, rotation stopper 24,
accommodating cavity 1a, volute outlet 2a, water spraying port 11a, arc surface 11al, flow channel inlet 12a, flow channel 12b, flow channel outlet 12c, first flow channel cavity 12b1, filter screen frame 12b2, second flow channel passage 12b3,
upper volute 201, lower volute 202, volute cavity 203, volute inlet 204, assembly port 205,
first locking member 111, second locking member 221, first spiral guide member 121, second spiral guide member 21, first spiral guide portion 121a, first guide oblique portion 121b, second spiral guide portion 21a, second guide oblique portion 21b, centrifugal impeller 123, driving device 122, drive shaft 125,
flip assembly 221a, first locking surface 1111, second axis 2211, limiting protrusion 2212, abutting member 2213, second locking surface 2214, counterweight member 222;
central column 241, first annular cavity 242, central hole 243, second annular cavity 244,
recess 1101, water spraying cover 1102, surface 1201, handle 1202, first axis 1203, drive wheel 1204, driven wheel 1205, bottom cover 1206, and inlet cover 1207.

### DESCRIPTION OF THE EMBODIMENTS

In order to make those skilled in the art better understand the present invention and thereby define the scope of the present invention more clearly, the present invention is described below in detail with respect to some specific embodiments of the present invention. It should be noted that the following description only relates to some specific embodiments of the inventive concept and are only part of the embodiments of the present invention, specific and direct descriptions of relevant structures are merely for the convenience of understanding the present invention, and the specific features do not, of course, directly limit the implementation scope of the present invention. Conventional choices and alternatives made by those skilled in the art under the guidance of the inventive concept should be considered within the scope of the present invention.

The present invention provides a cleaning robot, where a volute is spirally provided to approach or move away in a vertical direction relative to an upper cover and to align a volute outlet with a water spraying port on the upper cover for locking to maintain the robot in a first operating state; when steering is required, a driving device stops working, and the volute is vertically displaced under the action of a volute resetting mechanism to release locking of a rotation locking mechanism; the driving device is then restarted to drive the volute to continue spiral movement, and the volute outlet is aligned with the water spraying port on the upper cover for locking to maintain the robot in a second operating state. Here, the water spraying port to be aligned with for realizing the second operating state is different from that to be aligned with for realizing the first operating state, so that different water spraying ports are aligned separately to spray water in the first operating state and the second operating state, which allows the robot to travel in different directions for cleaning.

Preferably, water is sprayed in opposite directions in the first operating state and the second operating state to allow the robot to turn around when hitting a wall or sensing an obstacle.

The present invention also provides a steering device for a cleaning robot, which is a related structure having the above-described steering function.

The present invention also provides a cleaning method based on the above-described cleaning robot, which is particularly suitable for cleaning watery places such as swimming pools.

### Embodiment I

A cleaning robot is configured to perform a cleaning operation in a swimming pool to clean a bottom wall of the swimming pool or garbage in the water to achieve the purpose of cleaning the swimming pool.

The cleaning robot 1 has a cleaning body 12, wheels for traveling are provided on a bottom surface of the cleaning body 12, the wheels include drive wheels and driven wheels, where the drive wheels are coupled to a driving device 122 such as a motor to be rotatable tor drive, and the driven wheels are freely rotatable wheels to be driven to travel by the drive wheels.

In the present embodiment, there are four wheels, including one driving wheel 1204 and three driven wheels 1205, where the driving wheel 1204 has a shape similar to that of one driving wheel 1204 and different from the other two driven wheels 1205, the driving wheel 1204 and the driven wheel 1205 having the similar shape are arranged in pairs on both sides of the cleaning body 12 and are both rotatably arranged about a first axis 1203, and the other two driven wheels 1205 are respectively arranged on both sides of the first axis 1203. Here, the driving wheel 1204 and the driven wheel 1205 having the similar shape constitute a directional wheel set, and are both directional wheels, while the other two driven wheels 1205 are universal wheels.

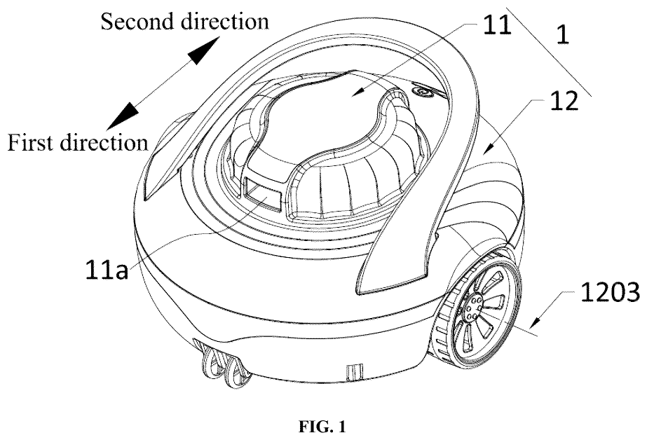

As shown in FIGS. 1-3, the cleaning robot 1 is composed of an upper cover 11 and the cleaning body 12, the upper cover 11 is fastened to the cleaning body 12 to form a whole, and the upper cover 11 and the cleaning body 12 may be fixedly connected or detachably connected, where the detachable connection means that a user can independently disassemble them, and the fixed connection means that they are not detachable except for violent disassembly, for example, they are welded together. Relatively speaking, the detachable connection results in better maintenance convenience of the cleaning robot, but may cause equipment damage due to unauthorized disassembly. In practice, the upper cover 11 and the cleaning body 12 may be fixedly connected or detachably connected depending on whether the cleaning robot needs to support self-service maintenance.

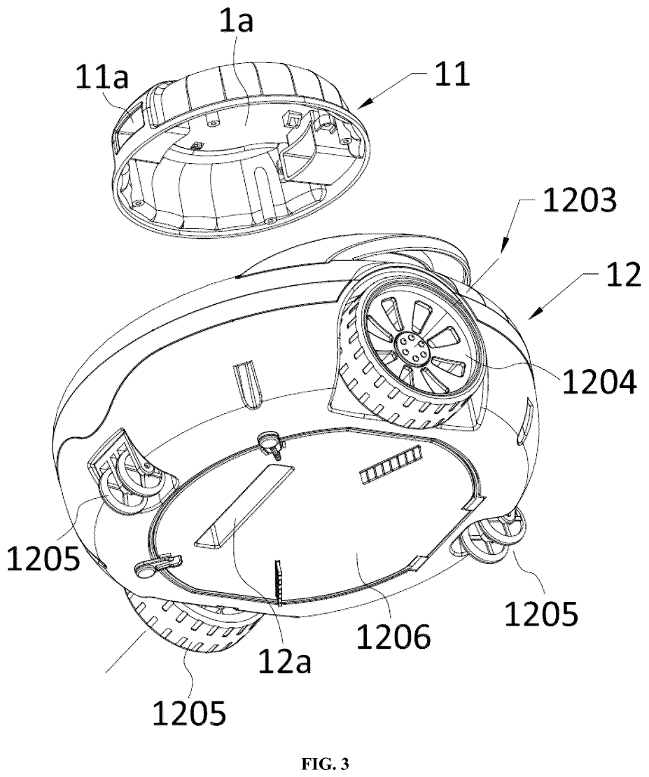

As shown in FIG. 3, each of the wheels is arranged on the bottom surface of the cleaning body 12, so that the cleaning robot can travel in a first direction or a second direction, where the first direction and the second direction form a 180° with each other, as shown in FIG. 1.

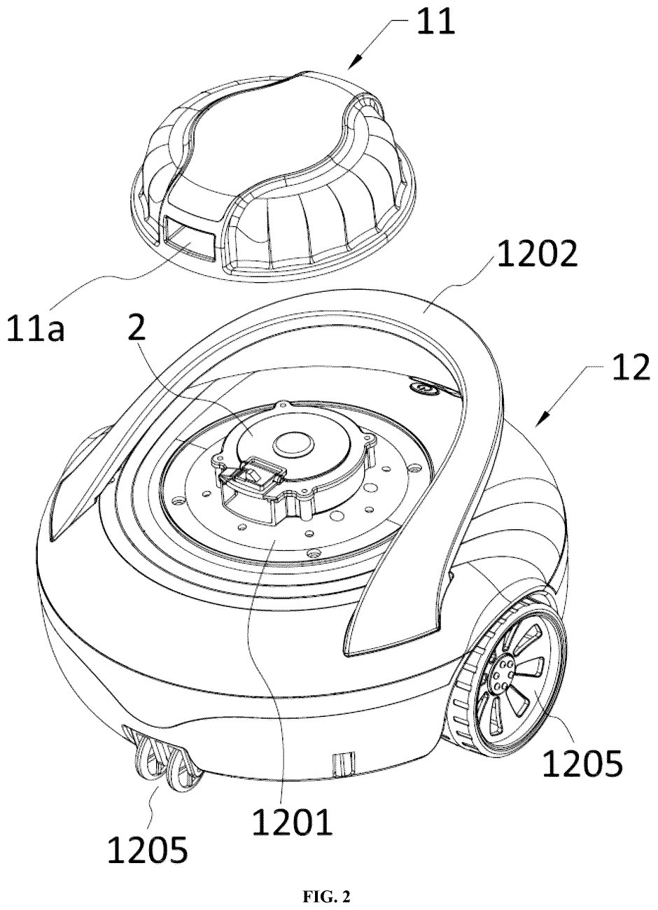

In the present embodiment, an accommodating cavity 1a is formed between the upper cover 11 and the cleaning body 12, and the accommodating cavity 1a is constituted by a cavity recessed in the upper cover 11, as shown in FIG. 3. A surface 1201 is formed on an upper surface of the cleaning body 12. As shown in FIG. 2, the upper cover 11 is fastened to the surface 1201 with an opening facing downward, thereby forming the accommodating cavity 1a. Of course, in other embodiments, it is possible to vary the position in which the accommodating cavity 1a is formed. For example, a cavity is recessed in the upper cover 11 to form an upper half of the accommodating cavity 1a and a cavity is recessed on the upper surface of the cleaning body 12 to form a lower half of the accommodating cavity 1a. That is, the accommodating cavity 1a is formed in both the upper cover 11 and the cleaning body 12. Alternatively, in further embodiments, the accommodating cavity 1a is completely formed by a cavity recessed on the upper surface of the cleaning body 12, in which case the upper cover 11 may be a planar sheet-like member. A handle 1202 is also provided on the cleaning body 12 for the user to take.

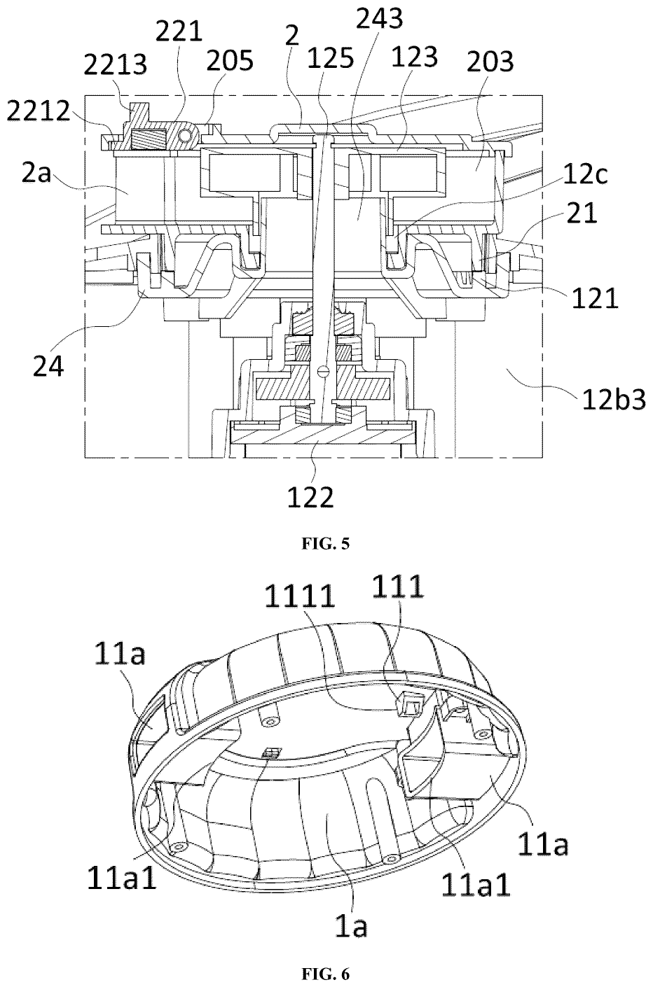

As shown in FIG. 6, both sides of the accommodating cavity 1a are respectively provided with a water spraying port 11a, and the water spraying ports 11a communicate the accommodating cavity 1a with the outside. In the present embodiment, since the accommodating cavity 1a is formed by a cavity recessed in the upper cover 11, the water spraying ports 11a are arranged on a sidewall of the upper cover 11 in a penetrating manner.

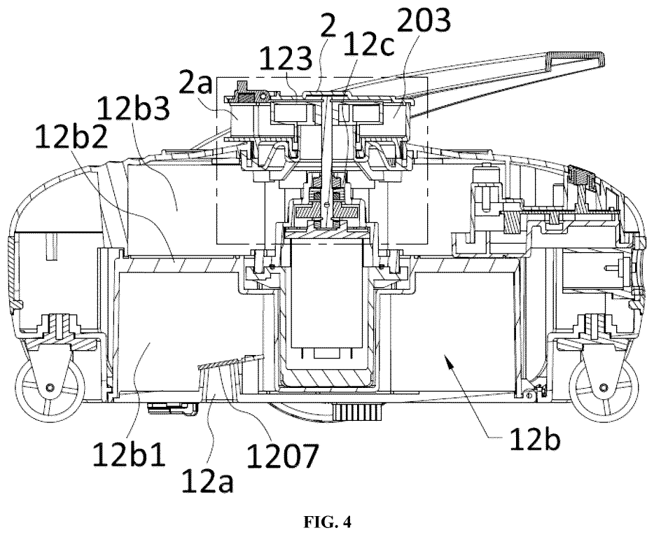

As shown in FIG. 4, a flow channel 12b is formed in the cleaning body 12, a flow channel inlet 12a is formed at a front end of the flow channel 12b, and a flow channel outlet 12c is formed at a rear end thereof, the flow channel inlet 12a communicates the flow channel 12b with the outside to be formed an inlet of the flow channel 12b, the flow channel outlet 12c communicates the flow channel 12b with the accommodating cavity 1a to be formed as an outlet of the flow channel 12b, thereby forming a cleaning flow channel composed of the flow channel inlet 12a, the flow channel 12b, the flow channel outlet 12c, the accommodating cavity 1a and the water spraying port 11a in sequence. A filter element (not shown in the figure) is provided in the cleaning flow channel. For example, a filter screen or a filter cartridge is provided as the filter element, so that after water and garbage are be sucked into the cleaning flow channel together, the filter element separates the water from the garbage, the garbage is collected by the filter element, and the filtered clean water is sprayed out from the water spraying port 11a, thereby achieving the purpose of cleaning swimming pools and other places.

In the present embodiment, the flow channel 12b includes a first flow channel cavity 12b1 provided in a lower region of the cleaning body 12 and a second flow channel passage 12b3 provided in an upper region of the cleaning body 12; the first flow channel cavity 12b1 and the second flow channel passage 12b3 are separated by a filter screen frame 12b2 to which a filter screen (not shown in the figure) is attached, the flow channel inlet 12a is communicated with the first flow channel cavity 12b1, and the flow channel outlet 12c is communicated with the second flow channel passage 12b3, so that garbage is collected in the first flow channel cavity 12b1 from the flow channel inlet 12a.

Preferably, an openable bottom cover 1206 is provided on the bottom surface of the cleaning body 12, the flow channel inlet 12a is arranged on the bottom cover 1206, and an inlet cover 1207 is provided at the flow channel inlet 12a. Here, the bottom cover 1206 is configured to take out the garbage collected in the first flow channel cavity 12b1 after being opened, and the inlet cover 1207 is opened by the water flow or closed under its own gravity.

As shown in FIG. 4, each of the wheels is convexly arranged on the bottom surface of the cleaning body 12, so that a gap is formed between the cleaning body 12 and the bottom wall of the swimming pool, and the flow channel inlet 12a is arranged on the bottom surface of the cleaning body 12, so that garbage on the bottom wall of the swimming pool can be cleaned during travel of the cleaning robot. Most preferably, the flow channel inlet 12a is an elongated opening and is arranged parallel to the first axis direction.

As shown in FIG. 2, a volute 2 is provided in the accommodating cavity 1a, the volute 2 is movably fitted in the accommodating cavity 1a, so that the volute 2 can rotate or lift in the accommodating cavity 1a, and the volute 2 is also locked and held at a certain position, that is, the volute 2 can be movably locked in the accommodating cavity 1a.

As shown in FIG. 4, a volute cavity 203 is formed in the volute 2, a volute inlet 204 in communication with the volute cavity 203 is provided in a lower portion of the volute 2, a volute outlet 2a is provided in a radial direction of the volute 2, a centrifugal impeller 123 is further provided in the volute 2, and the centrifugal impeller 123 is rotatably mounted in the volute cavity 203 of the volute 2. Here, the centrifugal impeller 123 is rotatable with respect to the cleaning body 12 but has a fixed assembly height, while the volute 2 is rotatable and liftable up and down with respect to the cleaning body 12. The driving device 122, preferably a motor, is arranged in the cleaning body 12, and the centrifugal impeller 123 is coupled to a drive shaft 125 of the driving device 122, so that the centrifugal impeller 123 is driven to rotate by the driving device.

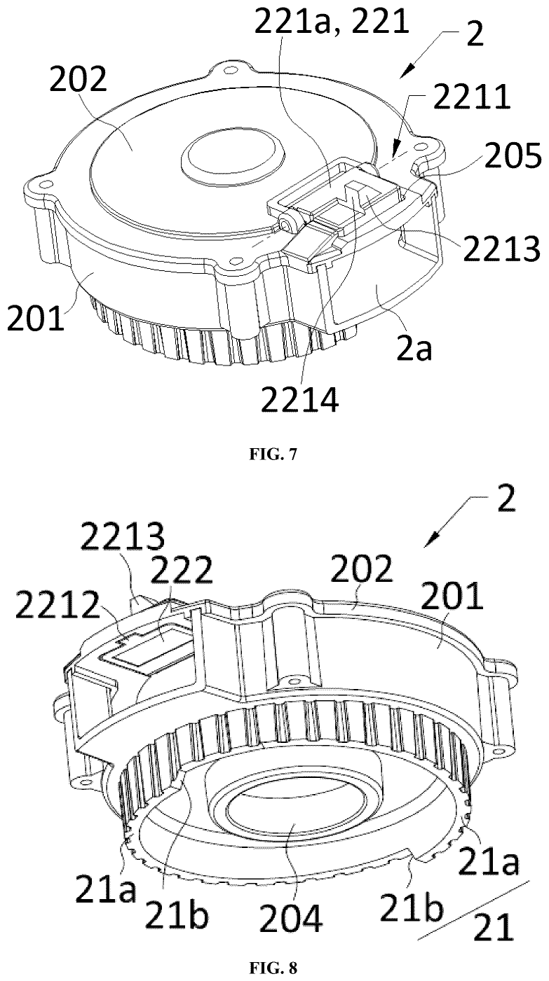

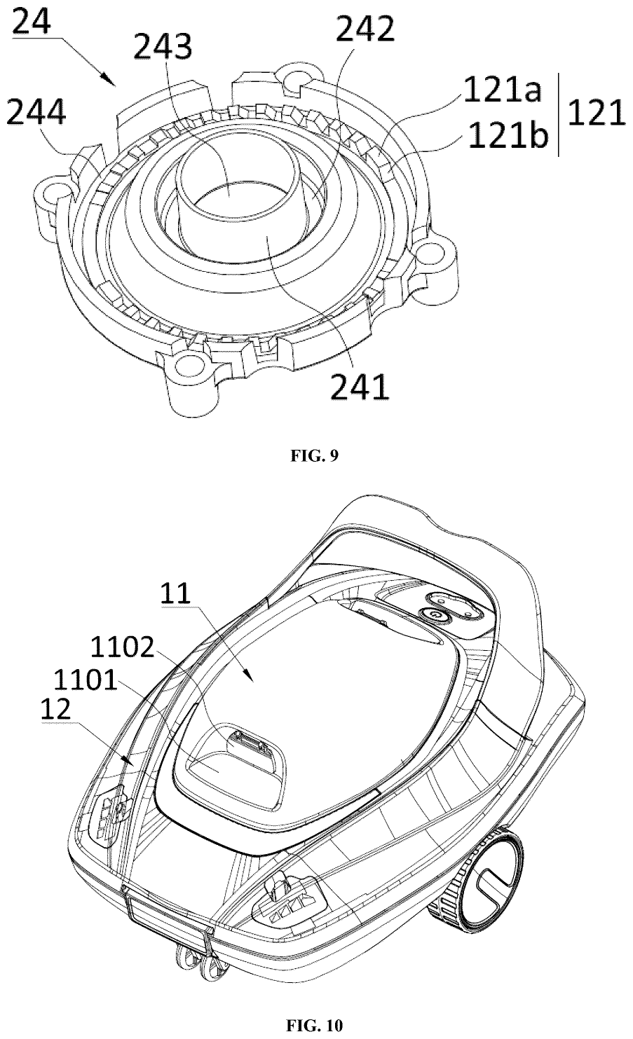

As shown in FIGS. 7-8, to mount the centrifugal impeller 123 in the volute 2, the volute 2 may be composed of an upper volute 201 and a lower volute 202 which are fixed by screws.

As shown in FIGS. 3 and 6, since the two water spraying ports 11a of the accommodating cavity 1a are arranged in 180° opposite directions, the volute 2 has only one volute outlet 2a, and the two water spraying ports 11a are fixedly arranged with respect to the cleaning body 12 and are respectively arranged in the first direction and the second direction; and since the volute outlet 2a is rotatably movably arranged, the volute outlet 2a is aligned with one of the two water spraying ports 11a to spray water.

When the volute outlet 2a is aligned with and communicated with one of the water spraying ports 11a, water filtered out of garbage by the filter element is sprayed out from the water spraying port 11a. Similarly, when the volute outlet 2a is aligned with and communicated with the other water spraying port 11a, water is sprayed out from the other water spraying port 11a. Each of the two water spraying states corresponds to a traveling direction of the cleaning robot, and may also be referred to as an operating state. If the cleaning robot itself is taken as a body, one of the two water spraying states corresponds to forward traveling, and the other corresponds to backward traveling, that is, the cleaning robot travels in the first direction or the second direction respectively, so that the cleaning robot of the present embodiment has a steering function.

Preferably, an outer sidewall of the volute outlet 2a and an inner sidewall of the water spraying port 11a are both in an arc shape and correspond to each other in size and position, so that 100% alignment between the volute outlet 2a and the water spraying port 11a can be achieved to reduce water spraying resistance. Obviously, if they are not 100% aligned, part of the sprayed water may impact an inner wall of the water spraying port 11a, causing pressure loss and reducing the efficiency. Alternatively, when there is a large gap between the volute outlet 2a and the water spraying port 11a, the water may be discharged from the gap and then sprayed out from the other water spraying port 11a after passing through the accommodating cavity 1a. As shown in FIG. 6, an arc surface 11al is formed at an inner side of the water spraying port 11a to facilitate alignment of the volute outlet 2a with the water spraying port to spray water.

In the present embodiment, the volute outlet 2a and the water spraying port 11a constitute isoflux channels. That is, they are of equal size everywhere. For example, they are rectangular cavities or cylindrical cavities. In other embodiments, the volute outlet 2a and the water spraying port 11a constitute expanded channels. That is, their internal sizes gradually increase from the inside to the outside, for example, forming a flared channel.

In order to achieve alignment fit between the volute 2 and one of the water spraying ports 11a, a rotation locking mechanism is formed between the cleaning body 12 and the volute 2, and the rotation locking mechanism is composed of a first locking member 111 and a second locking member 221 which are respectively provided on the upper cover 11 and the cleaning body 12. A first locking surface 1111 is provided on the first locking member 111, a second locking surface 2214 is provided on the second locking member 221, and the first locking surface 1111 and the second locking surface 2214 abut against each other to limit rotation of the volute 2. Here, the first locking member 111 and the second locking member 221 are both vertically arranged planes so as to be limited against each other.

Since the two water spraying ports 11a are arranged in opposite directions, there are also two first locking members 111 which are correspondingly arranged. For example, in the present embodiment, the two first locking members 111 are formed on an inner surface of the upper cover 11.

As shown in FIGS. 7 and 8, the second locking member 221 is movably arranged on a top surface of the volute 2 and located above the volute outlet 2a, an assembly port 205 is provided on the volute 2, a second axis 2211 is provided at one side of the second locking member 221 so that the second locking member 221 is hingedly movably connected to the volute 2; a stop block is convexly provided on the second locking member 221 and is formed as an abutting member 2213; the second locking surface 2214 is arranged on one side of the abutting member 2213, and a limiting protrusion 2212 is provided on the other side away from the second axis 2211; and the limiting protrusion abuts against the assembly port 205 to limit an angle at which the second locking member 221 is opened by the water flow, so that a maximum opening angle thereof is substantially flush with a top surface of the volute outlet 2a. In addition, a counterweight member 222 is provided on the second locking member 221 on one side of the second axis 2211 to drive the second locking member 221 to rotate axially about the second axis 2211 when the volute outlet 2a is not spraying water so as to displace the abutting member 2213 downward to disengage from the first locking member 111.

A rotation stopper 24 is mounted at the flow channel outlet 12c, and the rotation stopper 24 is mounted below the volute 2 and through which an output shaft of the motor passes. A center column 241 is provided at a center of the rotation stopper 24, a center hole 243 is formed in the center column 241, and a first annular cavity 242 and a second annular cavity 244 are respectively provided at a periphery of the central column 241. The first annular cavity 242 is used for an annular wall forming the volute inlet 204 to be fitted therein, and the second annular cavity 244 is used for an annular wall forming the first spiral guide member to be fitted therein.

In the present embodiment, rotation locking of the volute 2 is also achieved by a spiral guide mechanism which is configured to guide the volute 2 to rise and fall along a spiral track when the volute rotates in the accommodating cavity 1a. That is, the volute 2 not only rotates in a circumferential direction but also displaces in a vertical direction, and overlaying the two moving directions form a spiral track of the volute 2 in the accommodating cavity 1a for upward and downward movement.

To this end, the first spiral guide member is arranged in the second annular cavity 244, and a second spiral guide member is provided at a lower surface of the volute 2, the first spiral guide member includes two first spiral guide portions 121a and two first guide oblique portions 121b, the first spiral guide portions 121a and the first guide oblique portions 121b have a bevel respectively, one of the first spiral guide portions 121a and one of the first guide oblique portions 121b constitute a guide unit, and each guide unit occupies a 180° range, so that the two guide units are centrally symmetrically arranged. Similarly, the second spiral guide member is also composed of a second spiral guide portion 21a and a second guide oblique portion 21b.

In the present embodiment, a volute resetting mechanism is also provided, and the volute resetting mechanism is implemented by gravity of the volute 2, that is, buoyancy of the volute 2 in water is less than its own gravity. When the volute 2 rotates, the volute 2 is spirally lifted due to guiding action of the first spiral guide member and the second spiral guide member until the volute outlet 2a is aligned with one of the water spraying ports 11a, and the rotation locking mechanism composed of the first locking member 111 and the second locking member 221 locks the rotation of the volute 2 to keep the volute in the aligned state, forming a first operating state; and when the cleaning robot stops traveling, the centrifugal impeller 123 stops working, so that the volute 2 no longer has a tendency to rotate, and the volute 2 undergoes downward displacement by gravity, causing the first locking member 111 to separate from the second locking member 221 to release the rotation locking of the volute 2, the volute 2 resumes a rotatable state, then the centrifugal impeller 123 is started again to drive the volute 2 to rotate, and the volute 2 moves upward again along the spiral track until the volute outlet 2a is aligned with the other water spraying port 11a and is locked, forming a second operating state.

The cleaning robot of the present embodiment operates as follows.
1. The cleaning robot is placed in the water and started, and travels in the first direction in the first operating state for cleaning.
2. When the cleaning robot encounters an obstacle or hits a wall, the cleaning robot senses such situation and stops traveling, the motor stops working to stop the centrifugal impeller 123, the volute 2 falls back down by gravity to release the rotation locking, and then the motor is started again to bring the cleaning robot into the second operating state again.
3. The cleaning robot travels for cleaning in the second operating state until encountering an obstacle or hitting a wall and then switches back to the first operating state again.
4. The cleaning robot repeats the above steps 2 and 3 by itself until the swimming pool is completely cleaned, and then the cleaning robot is shut down or taken out.

### Embodiment II

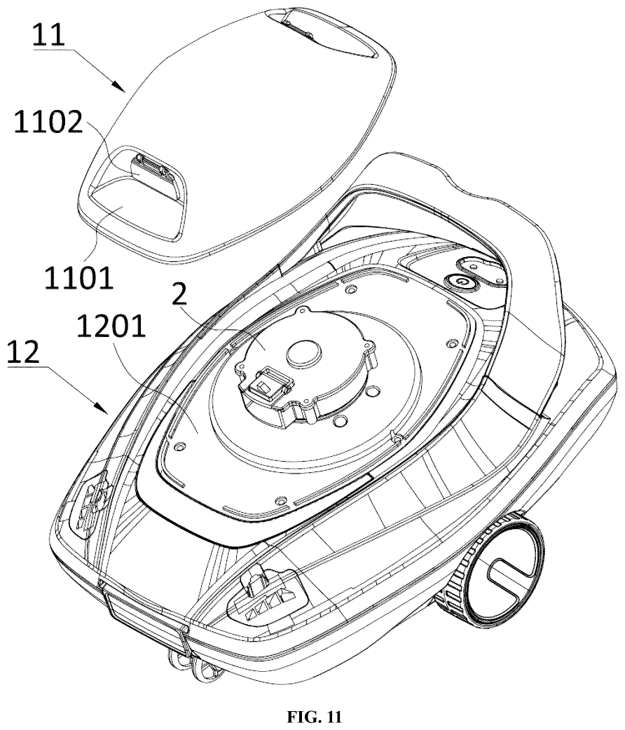

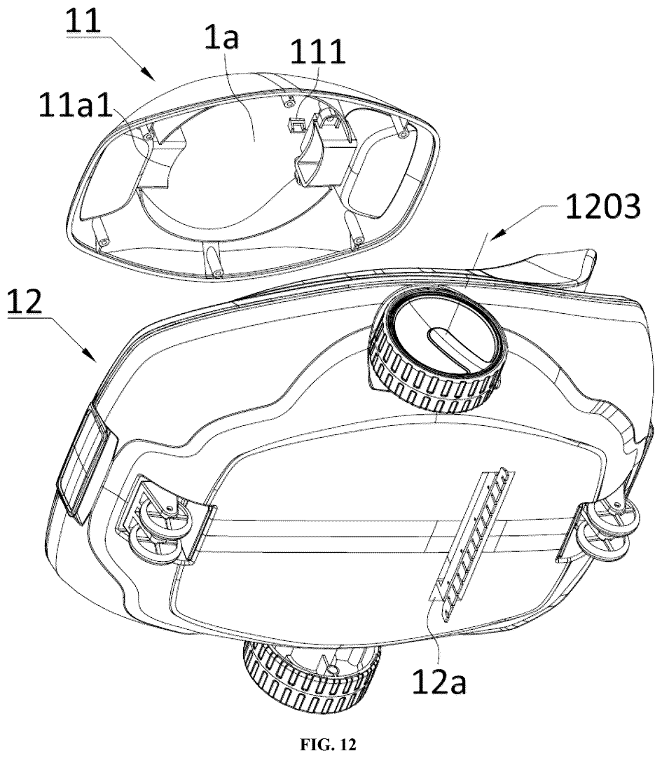

As shown in FIGS. 10-12, a cleaning robot has a main structure similar to that of the cleaning robot of Embodiment I, except that in the present embodiment, the upper cover 11 is arranged as a whole in a streamlined shape, that is, each sidewall of the upper cover 11 is beveled or curved instead of similar cylindrical shape in Embodiment I to reduce resistance and have a beautiful appearance.

Here, a recess 1101 is concavely provided at opposite ends of the upper cover 11, the two recesses 1101 are respectively provided in the first direction and the second direction, the water spraying ports 11a are communicated with the recesses 1101, and water spraying covers 1102 are also assembled outside the water spraying ports 11a, and the water spraying covers 1102 are hinged to the upper cover 11 at upper ends thereof, so that the water spraying covers 1102 are in a closed state under its own gravity, and the water spraying covers 1102 are washed open by water flow when water is sprayed out from the water spraying ports 11a.

Compared with Embodiment I, the shape of the upper cover 11 is varied in the present embodiment to have a streamlined shape to reduce resistance; when the cleaning robot is not in operation, the water spraying ports 11a are closed by the water spraying covers 1102 to prevent fine garbage from settling and adhering in the flow channel; and when the cleaning robot is in operation, the water flow can prevent garbage or microorganisms from adhering, thereby reducing cleaning requirement inside the cleaning body 12.

What is claimed is:

1. A cleaning robot for performing a cleaning operation in a swimming pool, comprising:
a cleaning body provided with a flow channel inlet, a flow channel and a flow channel outlet therein;
an upper cover mounted on the cleaning body, an accommodating cavity being formed between the upper cover and the cleaning body, the upper cover being provided with two water spraying ports in communication with the accommodating cavity, and the two water spraying ports being arranged at an angle of about 180° therebetween;
a volute movably provided in the accommodating cavity and having a volute cavity and a volute outlet and a volute inlet in communication with the volute cavity;
a spiral guide mechanism acting between the volute and the cleaning body to guide the volute to rise and fall along a spiral track when the volute rotates;
a rotation locking mechanism acting between the volute and the upper cover to lock rotation of the volute when the volute outlet is in communication with one of the two water spraying ports; and
a volute resetting mechanism for driving the volute to displace vertically in a direction opposite to the spiral track to unlock the rotation locking mechanism; and
wherein the volute inlet is communicated with the flow channel outlet, and a centrifugal impeller is provided in the volute cavity to drive water to flow inside and outside the cleaning robot.

2. The cleaning robot according to claim 1, wherein, when the volute outlet is aligned with one of the water spraying ports to form a first operating state, the centrifugal impeller rotates to drive water to flow in the cleaning robot, and the volute rises and falls along the spiral track under the guidance of the spiral guide mechanism to cause the rotation locking mechanism to lock the volute in the first operating state.

3. The cleaning robot according to claim 2, wherein, when the cleaning robot stops traveling, the centrifugal impeller stops rotating, the volute resetting mechanism drives the volute to rise and fall vertically to release locking of the rotation locking mechanism, then the centrifugal impeller rotates to drive water to flow, and under the guidance of the spiral guide mechanism, the volute outlet is aligned with the other water spraying port to form a second operating state, and the volute is locked by the rotation locking mechanism.

4. The cleaning robot according to claim 1, wherein, the spiral guide mechanism comprises a first spiral guide member provided on the cleaning body and a second spiral guide member provided on the volute; and
the first spiral guide member comprises two first spiral guide portions and two first guide oblique portions, the first spiral guide portions and the first guide oblique portions have a bevel respectively, one of the first spiral guide portions and one of the first guide oblique portions constitute a guide unit, and each guide unit occupies a 180° range.

5. The cleaning robot according to claim 4, wherein, the second spiral guide member (21) comprises two second spiral guide portions and two second guide oblique portions, the second spiral guide portions are complementary to the first spiral guide portions in shape, and the second guide oblique portions are complementary to the first guide oblique portions in shape.

6. The cleaning robot according to claim 1, wherein, the volute resetting mechanism is implemented by gravity of the volute.

7. The cleaning robot according to claim 6, wherein, the rotation locking mechanism is composed of a flip assembly and a first locking member which are separately provided on an upper surface of the volute and on a lower surface of the upper cover, the flip assembly is pivotally arranged on the cleaning body along a second axis, and an abutting member is provided on a side away from the second axis.

8. The cleaning robot according to claim 7, wherein, an assembly port is provided on an upper wall of the volute outlet, the flip assembly is mounted at the assembly port, and a counterweight member is further provided on the flip assembly.

9. The cleaning robot according to claim 6, wherein, a rotation stopper is provided at the flow channel outlet, and the first spiral guide member is arranged on the rotation stopper; and
a central column is provided at a center of the rotation stopper, a central hole is formed in the central column, the volute inlet is sheathed outside the central column, and a height of the central column is greater than a vertical lifting stroke of the volute.

10. The cleaning robot according to claim 1, wherein, the volute is composed of an upper volute and a lower volute, an inner edge of the water spraying port is in an arc shape, and an outer edge of the volute outlet is in an arc shape; or
the flow channel comprises a first flow channel cavity and a second flow channel passage, the first flow channel cavity and the second flow channel passage are separated by a filter screen frame, a filter screen is provided on the filter screen frame, the flow channel inlet is in communication with the first flow channel cavity, and the flow channel outlet is in communication with the second flow channel passage.

11. The cleaning robot according to claim 1, wherein, the water spraying port is further provided with a water spraying cover which is opened by water flow or closed under its own gravity.

12. A steering device for a cleaning robot for performing a cleaning operation in a swimming pool, comprising:
a centrifugal impeller for driving water to flow inside and outside the cleaning robot;
an upper cover mounted to a cleaning body of the cleaning robot and forming an accommodating cavity therebetween, the upper cover being further provided with two water spraying ports in communication with the accommodating cavity, and the two water spraying ports being arranged at an angle of about 180° therebetween;
a volute movably mounted in the accommodating cavity and having a volute cavity and a volute outlet and a volute inlet in communication with the volute cavity; and water driven by the centrifugal impeller being capable of applying a rotational moment to the volute to drive the volute to rotate when the water is discharged at the volute outlet;
a spiral guide mechanism acting between the volute and the cleaning body of the cleaning robot to guide the volute to rise and fall along a spiral track when the volute rotates;
a rotation locking mechanism acting between the volute and the upper cover to lock rotation of the volute when the volute outlet is in communication with one of the two water spraying ports; and
a volute resetting mechanism for driving the volute to displace vertically in a direction opposite to the spiral track to release rotation locking.

13. The steering device for the cleaning robot according to claim 12, wherein, a first operating state is formed when the volute outlet is aligned with one of the water spraying ports, the centrifugal impeller rotates to drive water to flow inside and outside the cleaning robot, and the volute rises and falls along the spiral track under the guidance of the spiral guide mechanism to cause the rotation locking mechanism to lock the volute in the first operating state; and
when the cleaning robot stops traveling, the centrifugal impeller stops rotating, the volute resetting mechanism drives the volute to rise and fall vertically to release locking of the rotation locking mechanism, then the centrifugal impeller rotates to drive water to flow, and under the guidance of the spiral guide mechanism, the volute outlet is aligned with the other water spraying port to form a second operating state, and the volute is locked again by the rotation locking mechanism.

14. The steering device for the cleaning robot according to claim 12, wherein, the spiral guide mechanism comprises a first spiral guide member provided on the cleaning body of the cleaning robot and a second spiral guide member provided on the volute;
the first spiral guide member comprises two first spiral guide portions and two first guide oblique portions, the first spiral guide portions and the first guide oblique portions have a bevel respectively, one of the first spiral guide portions and one of the first guide oblique portions constitute a guide unit, and each guide unit occupies a 180° range; and
the second spiral guide member comprises two second spiral guide portions and two second guide oblique portions.

15. The steering device for the cleaning robot according to claim 14, wherein, the second spiral guide portions are complementary to the first spiral guide portions in shape, and the second guide oblique portions are complementary to the first guide oblique portions in shape.

16. The steering device for the cleaning robot according to claim 12, wherein, the volute resetting mechanism is implemented by gravity of the volute.

17. The steering device for the cleaning robot according to claim 12, wherein, the rotation locking mechanism is composed of a flip assembly and a first locking member which are separately provided on an upper surface of the volute and on a lower surface of the upper cover; and
the flip assembly is pivotally arranged on the cleaning body along a second axis, and an abutting member is provided on a side away from the second axis.

18. The steering device for the cleaning robot according to claim 17, wherein, when the volute outlet is aligned with one of the water spraying ports, the abutting member is caused to abut against the first locking member for limiting under the action of water flow to lock rotation of the volute; and
when the water flow at the volute outlet stops, the flip assembly pivots about the second axis to disengage the abutting member from the first locking member to release rotation locking of the volute.

19. A cleaning method of a cleaning robot, comprising:
placing the cleaning robot in a place to be cleaned, aligning a volute outlet of the cleaning robot with one of two water spraying ports to form a first operating state, the cleaning robot traveling in a first direction and sucking and filtering water and then spraying out the water from the volute outlet, and collecting garbage in a garbage bin;
when the cleaning robot stops traveling due to an external factor, the centrifugal impeller stopping rotating to remove a rotational moment originally applied to a volute by the centrifugal impeller, and the volute vertically lifting and displacing under its own gravity to release rotation locking of the volute; then starting the centrifugal impeller again to guide water flow and apply a rotational moment to the volute, the volute outlet continuing rotating to align with the other water spraying port to form a second operating state, and a rotation locking mechanism locking the volute in the second operating state;
when the cleaning robot stops traveling again due to an external factor, repeating the previous step to switch to the first operating state; and
the robot cyclically switching between the first operating state and the second operating state until all cleaning operations are completed.

20. The cleaning method of the cleaning robot according to claim 19, wherein, the volute moves along a spiral track under the action of guide units provided in a spiral shape, and two guide units are centrally symmetrically arranged;
when the volute outlet is aligned with the water spraying port, the volute abuts against an upper cover for limiting;
the external factors are collision stop and induction stop; and
the water sprayed out from the water spraying port applies the rotational moment to the volute due to a centrifugal action of the centrifugal impeller.
